(19) United States
(12) Patent Application Publication
(10) Pub. No.: US 2014/0141358 A1
(43) Pub. Date: May 22, 2014

(54) SOLID OXIDE FUEL CELL COMPRISING POST HEAT-TREATED COMPOSITE CATHODE AND METHOD FOR PREPARING SAME

(71) Applicant: KOREA INSTITUTE OF SCIENCE AND TECHNOLOGY, (US)

(72) Inventors: Ji-Won SON, Seoul (KR); Jung Hoon PARK, Seoul (KR); Jong Ho LEE, Seoul (KR); Hae-Weon LEE, Seoul (KR); Byung Kook KIM, Seoul (KR); Hae June JE, Seoul (KR); Kyung Joong YOON, Seoul (KR)

(73) Assignee: KOREA INSTITUTE OF SCIENCE AND TECHNOLOGY, Seoul (KR)

(21) Appl. No.: 13/742,123

(22) Filed: Jan. 15, 2013

(30) Foreign Application Priority Data
Nov. 22, 2012 (KR) 10-2012-0132998

(51) Int. Cl. H01M 8/12

(52) U.S. Cl. CPC H01M 8/12
USPC 429/483; 429/488; 429/489; 427/115; 427/596; 427/585; 427/458

(57) ABSTRACT

Provided are a solid oxide fuel cell including: an anode support; a solid electrolyte layer formed on the anode support; and a composite cathode layer formed on the solid electrolyte layer, wherein the composite cathode layer is a porous sintered phase comprising an electrode material and an electrolyte material and a method for preparing same. The solid oxide fuel cell which includes a post-heat-treated nanocomposite cathode, which exhibits high interfacial strength and superior conductivity, exhibits superior power efficiency as well as superior durability.

### CROSS-REFERENCE TO RELATED APPLICATIONS

This application claims priority under 35 U.S.C. §119 to Korean Patent Application No. 10-2012-0132998 filed on Nov. 22, 2012, in the Korean Intellectual Property Office, the disclosure of which is incorporated herein by reference in its entirety.

### TECHNICAL FIELD

The present disclosure relates to a solid oxide fuel cell including a post-heat-treated nanocomposite cathode and a method for preparing same. More particularly, the following disclosure relates to a solid oxide fuel cell including a post-heat-treated nanocomposite thin film as a cathode and exhibiting improved stability and performance and a method for preparing same.

### BACKGROUND

A solid oxide fuel cells (SOFC) using a solid oxide, or a ceramic material, as an electrolyte has been developed mainly for large-scale power generation owing to many advantages including higher efficiency as compared to other types of fuel cells and fuel flexibility allowing use of various fuels other than hydrogen.

An SOFC for large-scale power generation is usually operated at high temperatures of 800-1000° C. Operation at such high temperatures causes interfacial reactions and incurs deterioration of performance due to thermal expansion mismatch of electrolyte, electrode and sealing materials, greatly limiting the materials and components that can be used and significantly aggravating performance reliability and cost-effectiveness. Accordingly, researches are actively carried out to lower the operation temperature of SOFCs for large-scale power generation below 700° C. In addition, lowering of the operation temperature is considered a prerequisite for easiness of heat management and size reduction of small-sized SOFCs for high-performance mobile power supplies. However, since lowering of the operation temperature leads to decreased electrolyte conductivity and electrode activity and, hence, decreased performance, use of new material or change in structure is necessary to compensate for them.

Since the major cause of power efficiency loss of an SOFC is polarization at the cathode, the cathodic polarization should be decreased to compensate for the performance loss of the SOFC. It is known that this can be achieved by maximizing specific surface area of the cathode by reducing the grain size of the cathode microstructure to nanometer scale and thereby increasing the density of active sites where catalytic reaction occurs.

The existing SOFC cathode is fabricated by first preparing a composite electrode powder via a powder process, coating it on an electrolyte by screen printing, spraying, etc. and then sintering at about 1000° C. (H. G. Jung, et al., Solid State Ionics 179 (27-32), 1535 (2008), H. Y. Jung et al., J. Electrochem. Soc. 154(5) B480 (2007)).

However, the cathode fabricated via the powder process is disadvantageous in that a nano-scale microstructure cannot be achieved since the grain size is limited by the particle size of the raw material (typically in the range from hundreds of nanometers to several micrometers) and, even when the cathode is prepared from nanometer-sized powder, a nano-scale microstructure cannot be achieved since grain growth occurs during the sintering at high temperature.

Although a nanostructured cathode can be successfully achieved via a nano-thin film process, the present state is merely in the stage of forming a single-phase thin-film cathode and characterizing its electrochemical performance. The single-phase electrode has problems including difference in thermal expansion coefficient with the electrolyte material, difficulty in thickness increase owing to structural instability at the operation temperature of the SOFC and severe degradation of the cathode with time (H. S. Noh et al., J. Electrochem. Soc. 158 (1), B1 (2011)).

To solve these problems, the inventors of the present disclosure have disclosed a method of depositing a thin film of an electrolyte-cathode composite material at high temperature and high pressure to obtain a porous structure and preparing a cathode having porous-gradient structure using same (Korean Patent Application No. 2011-0030841). However, there remain problems of limited conductivity in lateral direction and insufficient interfacial strength owing to the columnar structure characteristic of vacuum deposition.

### SUMMARY

The present disclosure is directed to providing a solid oxide fuel cell including a post-heat-treated nanocomposite cathode having high catalytic activity and thus exhibiting superior power efficiency as well as superior durability.

The present disclosure is also directed to providing a method for preparing a solid oxide fuel cell including a post-heat-treated nanocomposite cathode exhibiting high interfacial strength and superior conductivity

In one general aspect, there is provided a solid oxide fuel cell including: a) an anode support; b) a solid electrolyte layer formed on the anode support; and c) a composite cathode layer formed on the solid electrolyte layer,

wherein the composite cathode layer is a porous sintered phase comprising an electrode material and an electrolyte material.

In an exemplary embodiment of the present disclosure, the anode support may be selected from a group consisting of NiO-YSZ, NiO-ScSZ, NiO-GDC, NiO-SDC, NiO-doped BaZrO₃, Ru, Pd, Rd and Pt.

In another exemplary embodiment of the present disclosure, the electrode material may be one or more selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate.

In another exemplary embodiment of the present disclosure, the electrolyte material may be one or more selected from a group consisting of yttria-stabilized zirconia (YSZ), scandia-stabilized zirconia (ScSZ), gadolinia-doped ceria (GDC), samaria-doped ceria (SDC), doped barium zirconate (BaZrO₃) and barium cerate (BaCeO₃).

In another exemplary embodiment of the present disclosure, a volume ratio of the electrode material to the electrolyte material in the composite cathode layer may be from 2:8 to 8:2.

In another exemplary embodiment of the present disclosure, a volume ratio of the electrode material to the electrolyte material in the composite cathode layer may be from 3:7 to 7:3

In another exemplary embodiment of the present disclosure, the sintered composite cathode layer may have a grain size of 2-100 nm.

In another exemplary embodiment of the present disclosure, the solid oxide fuel cell may further include a current collecting layer on the composite cathode layer.

In another exemplary embodiment of the present disclosure, the solid oxide fuel cell may further include a buffer layer between the electrolyte layer and the composite cathode layer.

In another general aspect, there is provided a method for preparing a solid oxide fuel cell, including:

forming a solid electrolyte layer on an anode support;

forming a composite cathode layer wherein an electrolyte material and an electrode material are mixed on the solid electrolyte layer at 200-1000° C. and at a pressure of 10-50 Pa; and

post-heat-treating the composite cathode layer.

In an exemplary embodiment of the present disclosure, the method for preparing a solid oxide fuel cell may further include, before said forming the composite cathode layer, forming a buffer layer between the electrolyte layer and the composite cathode layer.

In another exemplary embodiment of the present disclosure, the electrode material may be one or more selected from a group consisting of LSM, LSF, LSC, LSCF, SSC, BSCF and bismuth ruthenate.

In another exemplary embodiment of the present disclosure, the electrolyte material may be one or more selected from a group consisting of YSZ, ScSZ, GDC, SDC, doped BaZrO₃ and BaCeO₃.

In another exemplary embodiment of the present disclosure, a volume ratio of the electrode material to the electrolyte material in the composite cathode layer may be from 2:8 to 8:2.

In another exemplary embodiment of the present disclosure, the volume ratio of the electrode material to the electrolyte material in the composite cathode layer may be from 3:7 to 7:3.

In another exemplary embodiment of the present disclosure, the composite cathode layer may be formed by a deposition method selected from pulsed laser deposition (PLD), sputter deposition, electron beam evaporation deposition, thermal evaporation deposition, chemical vapor deposition (CVD) and electrostatic spray deposition.

In another exemplary embodiment of the present disclosure, said post-heat-treating may be performed at 800-1100° C.

In another exemplary embodiment of the present disclosure, said post-heat-treating may be performed at a temperature range from the temperature of said forming the composite cathode layer to 1000° C.

In another exemplary embodiment of the present disclosure, said post-heat-treating may be stopped before the grain size of the composite cathode layer exceeds 100 nm.

In another exemplary embodiment of the present disclosure, the method for preparing a solid oxide fuel cell may further include, after said forming the composite cathode layer and before said post-heat-treating or after said post-heat-treating, forming a current collecting layer on the composite cathode layer.

The present disclosure provides a solid oxide fuel cell comprising a post-heat-treated nanocomposite cathode, which exhibits high interfacial strength and superior conductivity, and thus exhibiting superior power efficiency as well as superior durability and a method for preparing same.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 shows an image of a cathode immediately before post-heat-treating in preparation of a solid oxide fuel cell according to an exemplary embodiment of the present disclosure;

FIG. 2 shows images showing change in the shape of a cathode during post-heat-treating in preparation of a solid oxide fuel cell according to an exemplary embodiment of the present disclosure;

FIG. 3 shows a result of measuring impedance spectra of a solid oxide fuel cell according to an exemplary embodiment of the present disclosure and that of Comparative Example; and

FIG. 4 shows a result of measuring stability of a cathode included in a solid oxide fuel cell according to an exemplary embodiment of the present disclosure and that of Comparative Example with time.

### DETAILED DESCRIPTION OF EMBODIMENTS

Hereinafter, exemplary embodiments will be described in detail with reference to the accompanying drawings.

The present disclosure relates to a solid oxide fuel cell (SOFC) comprising an electrolyte-electrode composite cathode layer wherein an electrolyte material and an electrode material are mixed in molecular level and form a porous sintered phase to overcome difference in thermal expansion coefficients as well as structural instability and low conductivity at high SOFC operation temperature, which is obtained by thin film deposition, post-heat-treating, etc. and has high catalytic activity, and a method for preparing same.

The solid oxide fuel cell according to the present disclosure comprises: a) an anode support; b) a solid electrolyte layer formed on the anode support; and c) a composite cathode layer formed on the solid electrolyte layer, wherein the composite cathode layer is a porous sintered phase comprising an electrode material and an electrolyte material. That is to say, the composite cathode formed as a nanocomposite is sintered via a post-heat-treating process.

In an exemplary embodiment of the present disclosure, the anode support may be selected from a group consisting of NiO-YSZ, NiO-ScSZ, NiO-GDC, NiO-SDC, NiO-doped BaZrO₃, Ru, Pd, Rd and Pt, but is not limited thereto.

And, the electrode material may be one or more selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate, but is not limited thereto.

The electrolyte material may be one or more selected from a group consisting of yttria-stabilized zirconia (YSZ), scandia-stabilized zirconia (ScSZ), gadolinia-doped ceria (GDC), samaria-doped ceria (SDC), doped barium zirconate (BaZrO₃) and barium cerate (BaCeO₃), but is not limited thereto.

The anode support, the electrode material and the electrolyte material of the solid oxide fuel cell may be freely or selectively changed by those of ordinary skill in the art. The present disclosure is not limited by the selectin of the materials and it will be apparent that any solid oxide fuel cell comprising a cathode comprising such electrode material and electrolyte material and having a porous sintered phase is included in the scope of the present disclosure. However, it is preferred that the electrode material and the electrolyte material are selected such that they do not react chemically with each other but are mixed only physically by sintering or mixing.

The cathode layer of the solid oxide fuel cell is formed by thin film deposition. The electrode material and the electrolyte material which do not form a single material through reaction or dissolution form a sintered single material (electrode material-electrode material, or electrolyte material-electrolyte material) via a post-heat-treating process. The cathode layer has a porous phase wherein nanosized particles are uniformly mixed. As a result, since the three-phase electrolyte-electrode-gas interface can be maximized in nanometer scale, better performance efficiency can be achieved with much smaller thickness as compared to the existing art. Further, since grain growth occurs and interparticle bonding becomes stronger during the post-heat-treating process, structural and mechanical properties of the thin film are improved. As a consequence, mechanical stability is improved owing to enhanced interfacial adhesion with the electrolyte layer, and overall electrical resistance is remarkably decreased as conductivity in the lateral direction is improved owing to increased interconnection between the electrolyte material and the electrode material in the lateral direction. Accordingly, the solid oxide fuel cell comprising the post-heat-treated nanocomposite thin-film cathode according to the present disclosure has remarkably improved structural stability as compared to a thin-film cathode which has not undergone post-heat-treating and exhibits higher performance as compared to a cathode prepared via a powder process, as will be described in the Examples section.

In an exemplary embodiment of the present disclosure, a volume ratio of the electrode material to the electrolyte material in the composite cathode layer may be from 2:8 to 8:2, more specifically from 3:7 to 7:3. Within this range, the electrolyte material-electrode material-gas contact area is maximized and the interconnection between the electrolyte material and the electrode material is also maximized.

Specifically, the sintered composite cathode layer formed by the post-heat-treating may have a grain size of not greater than 100 nm. If the grain size is larger, the contact area with the gas decreases and cell performance may decrease due to electrode polarization. Accordingly, the grain size of the sintered composite cathode layer may be not greater than 100 nm, more specifically 2-100 nm.

In another exemplary embodiment of the present disclosure, the solid oxide fuel cell may further comprise a single-phase current collecting layer on the composite cathode layer or may further comprise a buffer layer between the electrolyte layer and the composite cathode layer. However, this is only optional and it will be obvious to those of ordinary skill in the art that the scope of the present disclosure is not limited thereby.

Hereinafter, a method for preparing a solid oxide fuel cell according to the present disclosure will be described.

The solid oxide fuel cell according to the present disclosure may be prepared by a method comprising: 1) forming a solid electrolyte layer on an anode support; 2) forming a composite cathode layer wherein an electrolyte material and an electrode material are mixed on the solid electrolyte; and 3) post-heat-treating the composite cathode layer.

Description about the anode support, the electrolyte material and the electrode material which were described above will not be given again to avoid redundancy. The formation of the solid electrolyte layer in the step 1) may be achieved according to a method commonly employed in the art.

In an exemplary embodiment of the present disclosure, the formation of composite cathode layer in the step 2) may be achieved by pulsed laser deposition (PLD) or sputter deposition. Further, the composite cathode layer may be formed by a physical vapor deposition (PVD) method such as electron beam evaporation deposition, thermal evaporation deposition, etc., chemical vapor deposition (CVD), electrostatic spray deposition, or the like. Alternatively, rather than deposition of a source powder, a deposition method whereby deposited particles are atomized or molecularized to form a plasma to allow for mixing in atomic/molecular scale may also be employed.

Specifically, when pulsed laser deposition (PLD) is employed, the composite cathode layer may be formed at 200-1000° C. and a pressure of 10 Pa or higher. In order to ensure uniform deposition by improving mobility of the deposited particles on the deposition surface and to ensure good adhesion and crystallinity of the resulting thin film, the deposition temperature needs to be 200° C. or higher. If the deposition temperature is not so high, the adhesion and crystallinity of the thin film may be further improved through the post-heat-treating. When the composite cathode layer is formed, the deposition temperature should not exceed 1000° C. When the deposition temperature exceeds 1000° C., the characteristics of nanoparticles of the thin film may be lost due to excessively large grain size and undesirable reaction with the electrolyte material, deterioration of the deposition apparatus, or the like may occur.

When composite cathode layer is formed, the deposition is performed at a pressure of 10 Pa or higher, more specifically 10-50 Pa, in order to achieve the porous structure at a deposition temperature which is higher than room temperature. If the deposition pressure is below 10 Pa when the deposition temperature is higher than room temperature, a dense thin film is formed owing to increased energy and mobility of the deposited material on the substrate surface. As a result, the porous structure desired for the SOFC electrode cannot be achieved.

Next, the post-heat-treating in the step 3) is performed. The post-heat-treating is essential for increasing connectivity of the composite cathode layer deposited as thin film in the lateral direction and enhancing adhesion at the interface. In the step 3), the composite cathode layer is sintered to achieve the characteristics described above.

Specifically, the post-heat-treating may be performed at 800-1100° C. Since the post-heat-treating is performed to induce grain growth following the deposition, the post-heat-treating temperature may be higher than the thin film deposition temperature, more specifically in a range from the temperature of the step 2) to 1100° C. If the post-heat-treating temperature is below the temperature of the step 2), sufficient grain growth may not be achieved. And, if the post-heat-treating temperature is above 1100° C., the composite cathode layer may become too dense and porosity may be lost. In addition, other components of the solid oxide fuel cell may be deformed by heat. To satisfy the temperature requirement of the post-heat-treating step, the post-heat-treating may be stopped before the grain size of the composite cathode layer exceeds 100 nm. The volume ratio of the electrode material and the electrolyte material in the cathode layer is the same as described above (from 2:8 to 8:2, specifically, from 3:7 to 7:3). For this, the post-heat-treating may be performed specifically for 30-90 minutes. However, the post-heat-treating time is not limited thereto as long as a grain size not greater than 100 nm can be achieved.

And, as described earlier, the method for preparing a solid oxide fuel cell may further comprise, before said forming the composite cathode layer (i.e. between the step 1) and the step 2)), forming a buffer layer between the electrolyte layer and the composite cathode layer. Also, the method for preparing a solid oxide fuel cell may further comprise, between the step 2) and the step 3) or after the step 3), forming a current collecting layer on the composite cathode layer.

As described above, since the composite thin-film cathode layer of the solid oxide fuel cell according to the present disclosure has a porous phase wherein nanosized particles are uniformly mixed, the three-phase electrolyte-electrode-gas interface can be maximized in nanometer scale. Accordingly, better performance efficiency can be achieved with much smaller thickness as compared to the existing art. Further, since grain growth occurs and interparticle bonding becomes stronger during the post-heat-treating process, structural and mechanical properties of the thin film are improved. As a consequence, mechanical stability is improved owing to enhanced interfacial adhesion with the electrolyte layer, and overall electrical resistance is remarkably decreased as conductivity in the lateral direction is improved owing to increased interconnection between the electrolyte material and the electrode material in the lateral direction. That is to say, in accordance with the present disclosure, the advantages of a thin-film cathode layer and a sintered cathode layer can be embodied at the same time.

### EXAMPLES

Hereinafter, the present disclosure will be described in more detail through examples and drawings.

### Preparation Example

### Preparation of Composite Cathode Layer Before Post-Heat-Treating (Step 3))

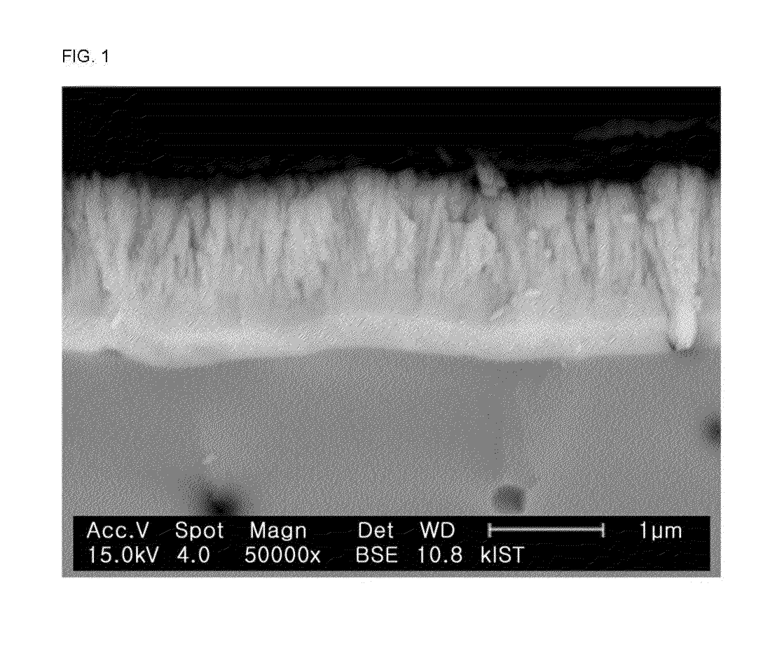

FIG. 1 shows a microscopic image of a composite cathode layer formed through the steps 1) and 2) of the preparation method of the present disclosure. GDC as electrolyte material and LSC as electrode material were uniformly mixed at a volume ratio of LSC:GDC=3:7. In the step 2), pulsed laser deposition (PLD) was performed at a substrate temperature of 700° C. and a pressure of 26.7 Pa. As seen from the figure, the composite cathode before post-heat-treating shows restricted material transfer in the lateral direction, which is characteristic of thin film deposition. Consequently, a thin film having a columnar structure is formed. This structure not only leads to decreased conductivity in the thin film in lateral direction but also is a major cause of lowering the interfacial strength of the thin film.

### Example

### Preparation of Post-Heat-Treated Nanocomposite Cathode Layer and Single Cell Comprising Same

NiO-YSZ composite powder was compacted and sintered according to the existing powder process. On the resulting anode support, a NiO-YSZ anode layer having a smaller particle size than the anode support was formed by screen printing. Then, a YSZ electrolyte layer was formed thereon by screen printing. After sintering at 1400° C. for 3 hours, a thick-film electrolyte of an anode-supported SOFC was completed.

Then, a 200-nm thick GDC buffer layer was deposited thereon by PLD to prevent reaction between LSC and YSZ. Deposition temperature was 700° C. and deposition pressure was 6.7 Pa.

A single cell was fabricated by forming a 3-μm thick cathode layer on the GDC buffer layer by PLD at 700° C. and a pressure of 26.7 Pa using a LSC-GDC 5:5 composite, which was post-heat-treated at 900° C. in the air for 1 hour.

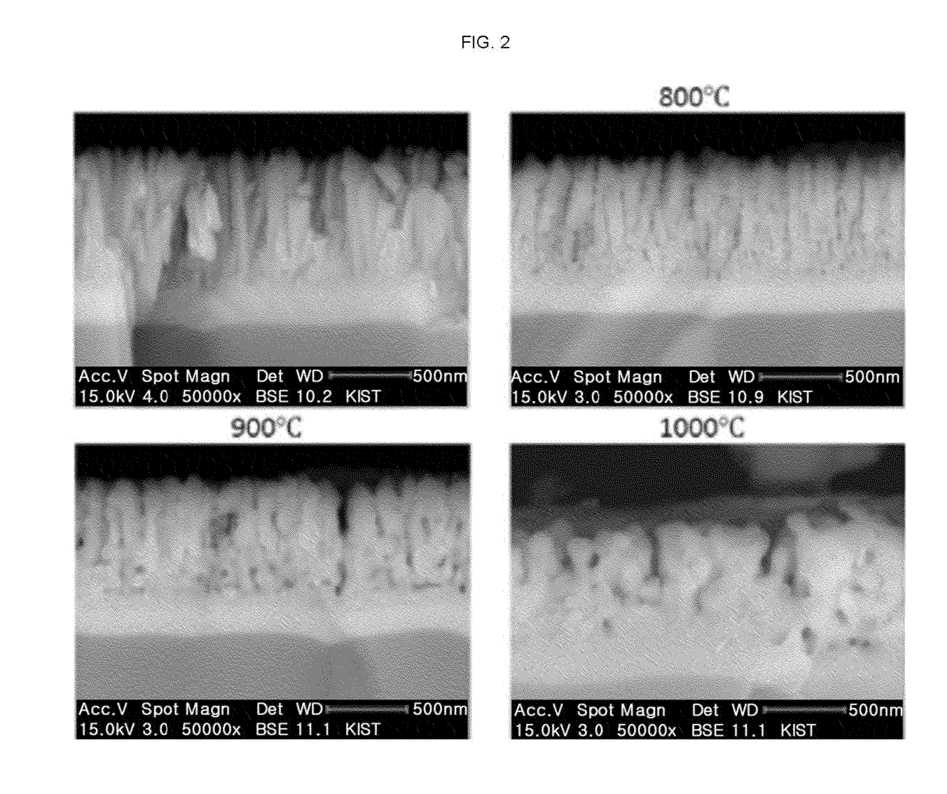

FIG. 2 shows images showing gradual change in the shape of the cathode layer during the post-heat-treating process. From FIG. 2, it can be observed that grain growth occurs in the lateral direction and connectivity between the columnar structure increases with the increase of the post-heat-treating temperature (800, 900 and 1000° C.). As used herein, the “grain size of the sintered cathode layer” means, as commonly understood by those skilled in the art, the length of the grain in the lateral direction. Although not presented as figures, grain growth of the same pattern was observed when the ratio of the electrode material and the electrolyte material in the step 2) was set differently.

### Comparative Example

### Preparation of Single Cell

A single cell was prepared in the same manner as Example except for the post-heat-treating step.

### Test Example 1

### Change in Cell Performance

The single cells of Example and Comparative Example were heated to 650° C. and impedance was monitored with time. Hydrogen containing 3% of water was used as a fuel and air was supplied to the anode and the cathode respectively at 200 sccm as an oxidizing agent. Electrochemical characteristics were analyzed using a Solartron impedance analyzer with an electrochemical interface (SI1260 and Sl1287).

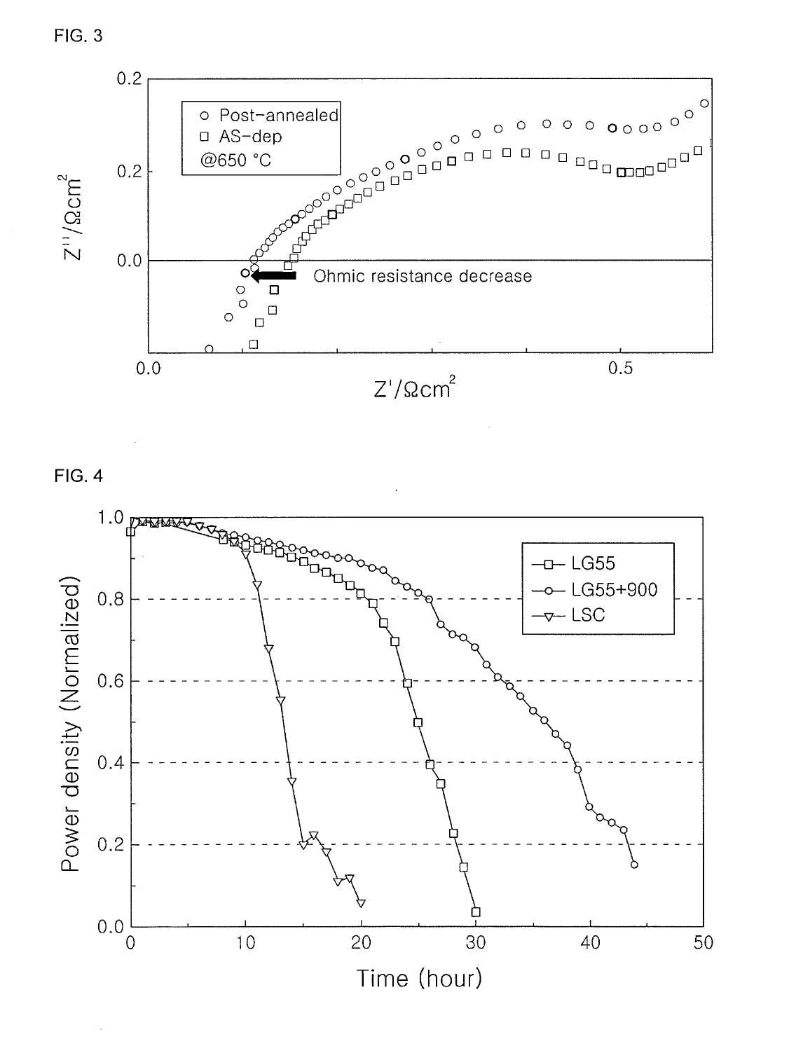

FIG. 3 shows a result of measuring impedance spectra of the single cells for comparison of performance. As seen from the figure, the single cell of Example exhibits decreased ohmic resistance owing to improved connectivity in the lateral direction (Example: Post-annealed, Comparative Example: As-dep).

### Test Example 2

### Change in Stability

In order to investigate the effect of the post-heat-treating on the structural and performance stability of the cathode, long-term stability was compared at 650° C., the operation temperature of a solid oxide fuel cell. FIG. 4 shows power density of LSC (single-phase LSC cathode), LG55 (LSC-GDC 5:5 cathode before post-heat-treating, Comparative Example) and LG55-900 (Example). As seen from the figure, the long-term stability increases in the order of single-phase thin film<nanocomposite thin film<post-heat-treated nanocomposite thin film. The post-heat-treated composite thin film shows very slow deterioration of performance even after long-term use.

While the present disclosure has been described with respect to the specific embodiments, it will be apparent to those skilled in the art that various changes and modifications may be made without departing from the spirit and scope of the disclosure as defined in the following claims.

What is claimed is:

1. A solid oxide fuel cell comprising:
an anode support; a solid electrolyte layer formed on the anode support; and
a composite cathode layer formed on the solid electrolyte layer,
wherein the composite cathode layer is a porous sintered phase comprising an electrode material and an electrolyte material.

2. The solid oxide fuel cell according to claim 1, wherein the anode support is selected from a group consisting of NiO-YSZ, NiO-ScSZ, NiO-GDC, NiO-SDC, NiO-doped BaZrO₃, Ru, Pd, Rd and Pt.

3. The solid oxide fuel cell according to claim 1, wherein the electrode material is one or more selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate.

4. The solid oxide fuel cell according to claim 1, wherein the electrolyte material is one or more selected from a group consisting of yttria-stabilized zirconia (YSZ), scandia-stabilized zirconia (ScSZ), gadolinia-doped ceria (GDC), samaria-doped ceria (SDC), doped barium zirconate (BaZrO₃) and barium cerate (BaCeO₃).

5. The solid oxide fuel cell according to claim 1, wherein a volume ratio of the electrode material to the electrolyte material in the composite cathode layer is from 2:8 to 8:2.

6. The solid oxide fuel cell according to claim 1, wherein the sintered composite cathode layer has a grain size of 2-100 nm.

7. The solid oxide fuel cell according to claim 1, which further comprises a current collecting layer on the composite cathode layer.

8. The solid oxide fuel cell according to claim 1, which further comprises a buffer layer between the electrolyte layer and the composite cathode layer.

9. A method for preparing a solid oxide fuel cell, comprising:
forming a solid electrolyte layer on an anode support;
forming a composite cathode layer wherein an electrolyte material and an electrode material are mixed on the solid electrolyte layer at 200-1000° C. and at a pressure of 10-50 Pa; and
post-heat-treating the composite cathode layer.

10. The method for preparing a solid oxide fuel cell according to claim 9, which further comprises, before said forming the composite cathode layer, forming a buffer layer between the electrolyte layer and the composite cathode layer.

11. The method for preparing a solid oxide fuel cell according to claim 9, wherein the electrode material is one or more selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate.

12. The method for preparing a solid oxide fuel cell according to claim 9, wherein the electrolyte material is one or more selected from a group consisting of yttria-stabilized zirconia (YSZ), scandia-stabilized zirconia (ScSZ), gadolinia-doped ceria (GDC), samaria-doped ceria (SDC), doped barium zirconate (BaZrO₃) and barium cerate (BaCeO₃).

13. The method for preparing a solid oxide fuel cell according to claim 9, wherein a volume ratio of the electrode material to the electrolyte material in the composite cathode layer is from 2:8 to 8:2.

14. The method for preparing a solid oxide fuel cell according to claim 9, wherein a volume ratio of the electrode material to the electrolyte material in the composite cathode layer is from 3:7 to 7:3.

15. The method for preparing a solid oxide fuel cell according to claim 9, wherein the composite cathode layer is formed by a deposition method selected from pulsed laser deposition (PLD), sputter deposition, electron beam evaporation deposition, thermal evaporation deposition, chemical vapor deposition (CVD) and electrostatic spray deposition.

16. The method for preparing a solid oxide fuel cell according to claim 9, wherein said post-heat-treating is performed at 800-1100° C.

17. The method for preparing a solid oxide fuel cell according to claim 9, wherein said post-heat-treating is performed at a temperature range from the temperature of said forming the composite cathode layer to 1100° C.

18. The method for preparing a solid oxide fuel cell according to claim 9, wherein said post-heat-treating is stopped before the grain size of the composite cathode layer exceeds 100 nm.

19. The method for preparing a solid oxide fuel cell according to claim 9, wherein which further comprises, after said forming the composite cathode layer and before said post-heat-treating or after said post-heat-treating, forming a current collecting layer on the composite cathode layer.
